(19) United States
(12) Patent Application Publication
(10) Pub. No.: US 2004/0122962 A1
(43) Pub. Date: Jun. 24, 2004

(54) Service environment integrity based service selection

(76) Inventors: Robert A. DiFalco, Portland, OR (US); Thomas E. Good, Portland, OR (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/328,530

(22) Filed: Dec. 24, 2002

(51) Int. Cl. G06F 15/16

(52) U.S. Cl. 709/229

(57) ABSTRACT

In a networked computing environment, a server is equipped to provide one or more services and to assure the integrity of the service components of the one or more services. Additionally, a client is equipped to determine whether to engage the server for one or more needed services, based at least in part on whether the integrity assurance provided by the server meets the integrity requirements for the needed services. In various embodiments, the integrity assurance is multi-level, including direct service providing components and one or more supporting components one or more layers removed from the direct service providing components.

### FIELD OF THE INVENTION

The present invention relates to the field of computing. More specifically, the present invention is related to trusted computing.

### BACKGROUND OF THE INVENTION

Advances in microprocessor, networking and related technologies have led to wide spread deployment and adoption of server-client based applications. Today, numerous services are offered by a plethora of servers for consumption by networked client devices of all kinds, including but not limited to computers, digital assistants, wireless phones, and so forth.

However, with the proliferation of servers and client devices, and the ubiquitous access afforded to these devices by local, regional and wide area networks, such as the Internet, executables and data are vulnerable to harm. Whether the harm is due to damage caused by a virus, an unauthorized access, or simply due to natural occurrences such as exposure to the elements, the importance of executable and data integrity and security cannot be overstated.

Accordingly, substantial amounts of effort have been invested by the industry in protecting and securing the executables and data, including but not limited to ensuring the parties with whom a client/server engages in the provision or consumption of services is authenticated and uncompromised. Numerous authentication, encryption/decryption, obfuscation, tamper resistant and other related techniques are known in the art.

However, the techniques known and practiced to-date are substantially limited to authenticating the parties with whom one engages in transaction, protecting the parties directly participating in the transactions and the transactions themselves.

Increasingly, for many applications, the protection or security offered by the prior art is insufficient. Accordingly, it is desirable to further improve the safety and security of client-server based service delivery and consumption.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an example computing environment, including a client device incorporated with the integrity assurance based service selection teachings of the present invention;

FIGS. 2a-2b illustrate the operational flow of the relevant aspects of the integrity assurance based service selection function FIG. 1, in accordance with two embodiments;

FIGS. 3a-3b illustrate the operational flow of the relevant aspects of the integrity assurance based service selection function FIG. 1, in accordance with two other embodiments;

FIG. 4 illustrates an example data structure suitable for use by a client to practice the present invention, in accordance with one embodiment;

FIGS. 5a-5b illustrate the operational flow of the relevant aspects of an integrity assurance manager of a server, in accordance with one embodiment;

FIG. 6 illustrates an example data structure suitable for use by a server to practice the integrity assurance aspect of the present invention, in accordance with one embodiment; and

FIG. 7 illustrates an example computer system suitable for use to practice the present invention, in accordance with one embodiment.

### DETAILED DESCRIPTION OF THE INVENTION

The present invention includes a method and apparatus for facilitating secure consumption of server provided services by client devices, through integrity assurance based service selection.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

### Terminology

Parts of the description will be presented in data processing terms, such as service, components, selection, broadcast, request, reply, and so forth, consistent with the manner commonly employed by those skilled in the art to convey the substance of their work to others skilled in the art. These terms are to be accordingly the common meanings as understood by those ordinarily skilled in the art. As well understood by those skilled in the art, these quantities take the form of electrical, magnetic, or optical signals capable of being stored, transferred, combined, and otherwise manipulated through electrical and/or optical components of a processor and its subsystems.

Part of the descriptions will employ various abbreviations, including but are not limited to:

| | |
|---|---|
| MD5 | Message Digest |
| SHA-1 | Secure HASH Algorithm |
| XML | Extensible Mark-up Language |

### Section Headings, Order of Descriptions and Embodiments

Section headings are merely employed to improve readability, and they are not to be construed to restrict or narrow the present invention.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

### Computing Environment with Client Equipped with Invention

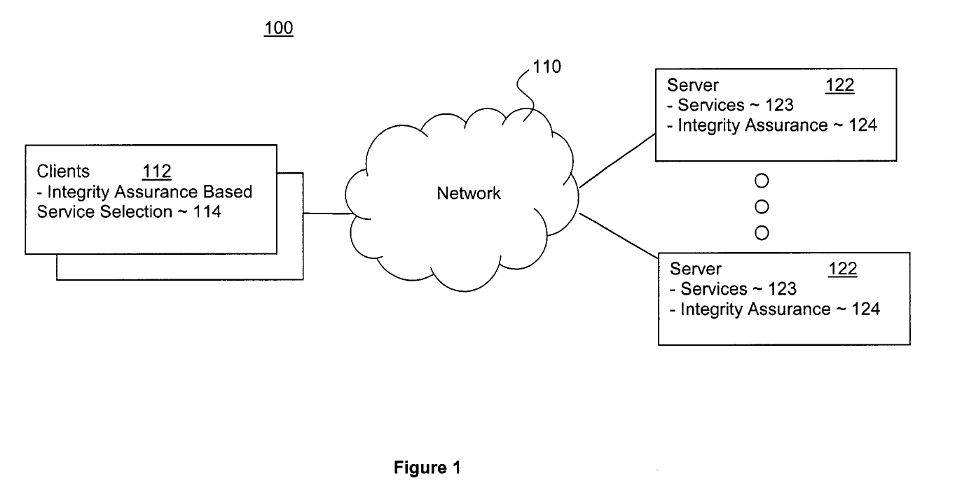

FIG. 1 illustrates an overview of an example computing environment, including a client incorporated with the integrity assurance based service selection feature of the present invention, in accordance with one embodiment. As illustrated, computing environment 100 includes a number of servers 122 equipped to provide a number of services 123 for consumption by networked clients 112, networked e.g. through network 110.

In addition to services 123, servers 122 are also equipped with integrity assurance managers 124 equipped to assure a client 112 of the integrity of the service providing components of services 123. More specifically, each integrity assurance manager 124 is equipped to be able to at least assure a client 112 of the integrity of the direct service providing component of a service 123 and one other supporting component. In general, each integrity assurance manager 124 is equipped be able to assure a client 112 of the integrity of the direct service providing component of a service 123 and supporting components up to n levels removed from the direct service providing component, where n is equal to or greater than 1.

In other words, for power, capacity and/or other reasons, servers 122 providing services 123 may be equipped to provide different levels of integrity assurance, some providing none, others providing a few, and yet others providing integrity assurance for components of many levels.

The meaning of the terms “direct service providing component” and “supporting components” of one or more levels removed from the “direct service providing component” may best be understood employing a component model, e.g. the Open System Interface (OSI) model, where supporting components can be thought of as supporting components of an application layer, a presentation layer, a session layer, a transport layer, a network layer, a data link layer and so forth.

Thus, if a client 112 invokes a component A to provide a service, and in the course of providing the service, components B, C, and so forth of “lower” layers are invoked to assist component A in the delivery of the requested service, component A is said to be the direct service providing component and components B, C and so forth are said to be the supporting components of one or more layers or levels removed from component A.

For the purpose of this application, the terms “layer” and “level” may be considered as synonymous.

Note that component A may be directly invoked or indirectly invoked e.g. through a web interface, an application programming interface or other interfaces of the like. Further, the OSI component or reference model is just one logical model or organization of the components of a service providing server 122. The present invention may be practiced with other logical models or organizations instead.

Continuing to refer to FIG. 1, client 112 is advantageously equipped with integrity assurance based service selection function 114. Function 114 enables client 112 to select a server 122 to provide a service based at least in part on the integrity assurance provided for a service 123 meeting the integrity assurance requirement of the client.

For example, a first server 122 may be equipped to provide services S1 and S2, and to assure integrity of the direct service providing components and supporting components up to L1 and L2 levels removed from the direct service providing components respectively, while a second server 122 is equipped to also provide S2, but able to assure integrity of the direct service providing component and supporting components up to L3 level removed from the direct service providing component, client 112 may elect to consume service S1 as provided by the first server 122 but consume service S2 as provided by the second server 122 instead, because while the first server 122 is able to meet the integrity requirement of client 112 for service S1, the second server is better able to meet the integrity requirement of client 112 for service S1. L1, L2 and L3 may all be integers.

Servers 122 and services 123 may be any servers and services known in the art, and client 112 may be any client devices known in the art, including but not limited to wireless mobile phones, palm-sized computing devices, personal digital assistants, laptop computers, desktop computers, set-top box and so forth. Similarly, network 110 may be any local, regional, and wide area, public and/or private networks known in the art.

### Server Integrity Check

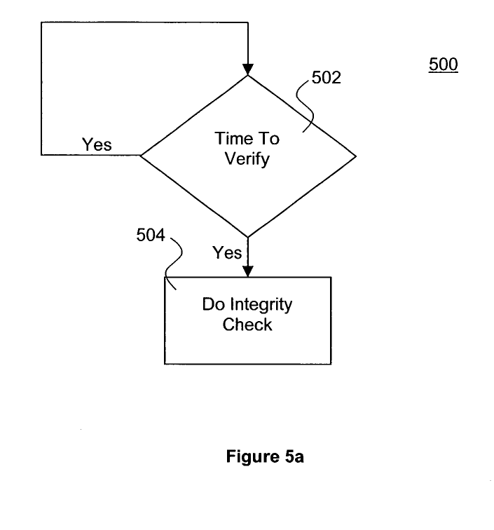

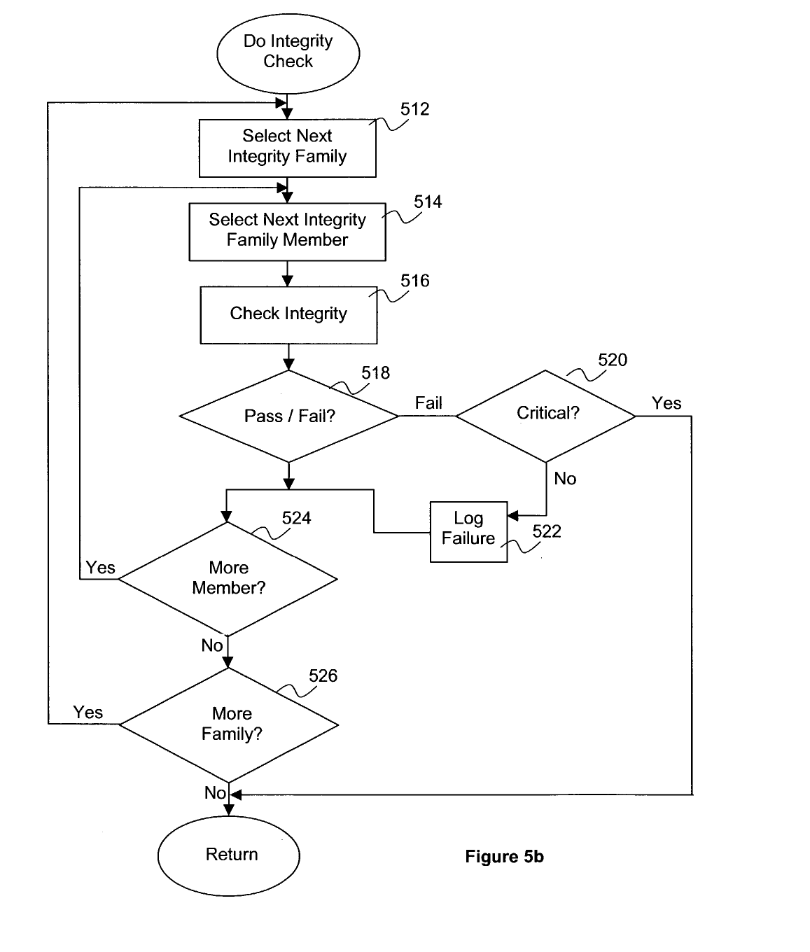

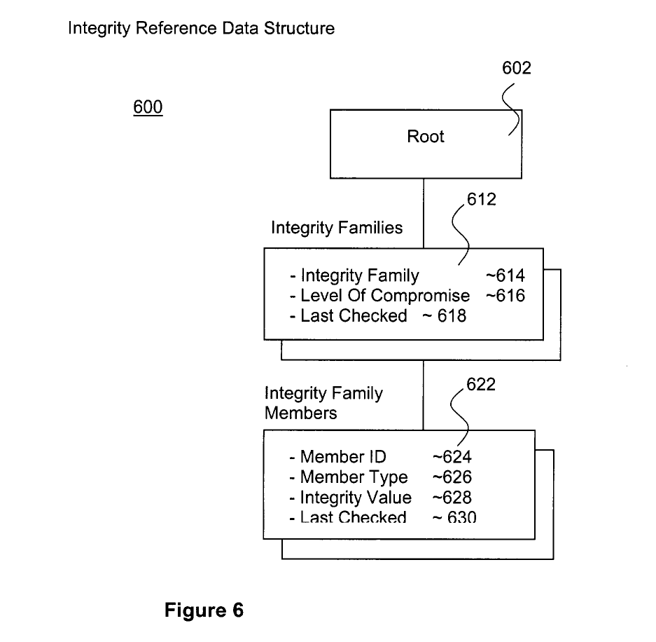

Referring now to FIGS. 5a-5b and 6 wherein integrity checking on an exemplary server, in accordance with one embodiment, is illustrated. More specifically, FIG. 5a illustrates the overall operational flow of the relevant aspects of integrity assurance manager 124, and FIG. 5b illustrates the operational flow of integrity checking, in accordance with one embodiment. FIG. 6 illustrates an associated data structure suitable for use to practice the integrity checking operations of FIGS. 5a-5b.

As illustrated in FIG. 6, for the embodiment, data structure 600 includes a root object 602 having a number of children Integrity Family objects 612, which in turn have a number of children Integrity Family Member objects 622.

Each Integrity Family object 612 includes in particular Integrity Family Identification and other attributes 614-618.

Integrity Family Identification attribute 614 is employed to identify a “family” of components, from the perspective of integrity assurance. One example for organizing service providing components, direct or assisting, of services 123 into integrity families, for integrity assurance purpose, is organizing the components as described earlier, in accordance with a component model, e.g. the OSI reference models. That is, components are organized in accordance with whether the support services they provide are application support services, presentation support services, session support services, and so forth.

In alternate embodiments, the components may be organized in terms of whether the components are members of the kernel of the operating system, a shared/non-shared library, whether the components have privileged access or not, and so forth. That is, the components are organized into the families of “privileged kernel components of the operating system”, “other privileged components of the operating system”, “non-privileged components of the operating system”, “privileged and non-shared library components”, “privileged and shared library components”, “non-privileged and non-shared library components”, “non-privileged and shared library components”, and so forth.

The term “privilege” as used herein refers to the “authority” of the component in performing certain operations on the host computing apparatus, e.g. whether the component may access certain registers and/or memory locations of the host computing apparatus. Typically, the delineation between “privileged” and “non-privileged” entities is operating system dependent.

In alternate embodiments, other manners of organization may be practiced instead.

An example of an other attribute 616-618 is a Level of Compromise attribute 616. Level of Compromise attribute 616 may e.g. be employed to denote a risk level in the event a member of the integrity family fails an integrity check. The risk level enables integrity assurance manager 124 or other security management entities to determine remedial actions, based on the risk level. For example, in one embodiment, the risk level enables integrity assurance manager 124 to determine whether soft fail over may still occur.

Integrity based soft fail over is the subject matter of co-pending application Ser. No. 10/251,545, entitled “Computing Environment and Apparatuses with Integrity based Fail Over”, filed Sep. 19, 2002.

Another example of other attributes 616-618 is a Last Checked attribute 618 denoting the last time when components of the integrity family were checked.

Each Integrity Family Member object 622 includes in particular Member ID attribute 624, Member Type attribute 626, Integrity Measure attribute 628 and Last Checked attribute 630.

Member ID attribute 624 is employed to specifically denote or identify a component, e.g. the name of an executable, a system data, and so forth, whereas Member Type attribute 626 is employed to denote the type of the named component, i.e. whether it is an executable, a system data, and so forth. Integrity Measure attribute 628 denotes the measure to be employed to determine whether the integrity family member is to be considered compromised or not, e.g. a signature of an executable or a system data value. Signatures may be in the form of MD5, SHA-1, or other hashing values of like kind. Last Checked attribute 630 is employed to denote the last time integrity of the component was checked.

In alternate embodiments, other data organizations may be employed instead.

As described earlier, FIGS. 5a-5b illustrate the operational flow of integrity checking by integrity assurance manager 124, in accordance with one embodiment. As illustrated, on invocation, e.g. after initialization of the host server, integrity assurance manager 124 determines if it is time to perform an integrity check on the host server, block 502. If not, integrity assurance manager 124 waits for the time to perform the integrity check. If it is time, integrity assurance manager 124 proceeds to perform the integrity check on the host server, block 504.

In alternate embodiments, integrity assurance manager 124 may perform the integrity check continuously. That is, integrity assurance manager 124 may perform an integrity check on the host server, as soon as an integrity check is finished, without waiting.

FIG. 5b illustrates the process of integrity check more fully. As illustrated, integrity assurance manager 124 first selects an integrity family to start verifying its component, e.g. components of a layer/level, or the privileged kernel of the operating system, block 512. Upon selecting an integrity family, integrity assurance manager 124 selects a member of the integrity family, block 514. The selection may be made using the earlier described data structure 600.

Upon selecting an integrity family member, integrity assurance manager 124 verifies its integrity, block 516. The action may include verifying the state of an executable component conforming to an expected signature, e.g. MD5 or SHA-1, or the state of a system data conforming to an expected value, and so forth.

At block 518, integrity assurance manager 124 determines whether the component/data passes the verification check or not. If integrity assurance manager 124 determines the component/data fails the verification check, it further determines if the failure is to be considered critical. The determination e.g. may be based on the severity of compromise associated with the component/data's integrity family, block 520.

If the failure is to be deemed as a critical failure, integrity assurance manager 124 immediately terminates the verification process, and initiates one or more remedial actions, e.g. the earlier described example soft fail over process. On the other hand, if the failure is not deemed to be a critical failure, integrity assurance manager 124 merely logs the non-critical integrity failure, block 522, and continues at block 524.

Back at block 518, if integrity assurance manager 124 determines the component/data passes the integrity verification, it also continues at block 524.

At block 524, integrity assurance manager 124 determines whether there are additional members of the selected integrity family remaining to be verified. If so, integrity assurance manager 124 returns to block 514, and continues from there as earlier described.

If all members of the selected integrity family have been verified, integrity assurance manager 124 continues at block 526, and determines whether there are additional integrity families remaining to be verified. If so, integrity assurance manager 124 returns to block 512, and continues from there as earlier described.

If all integrity families have been verified, the integrity verification is completed.

### Integrity Assurance Based Service Selection

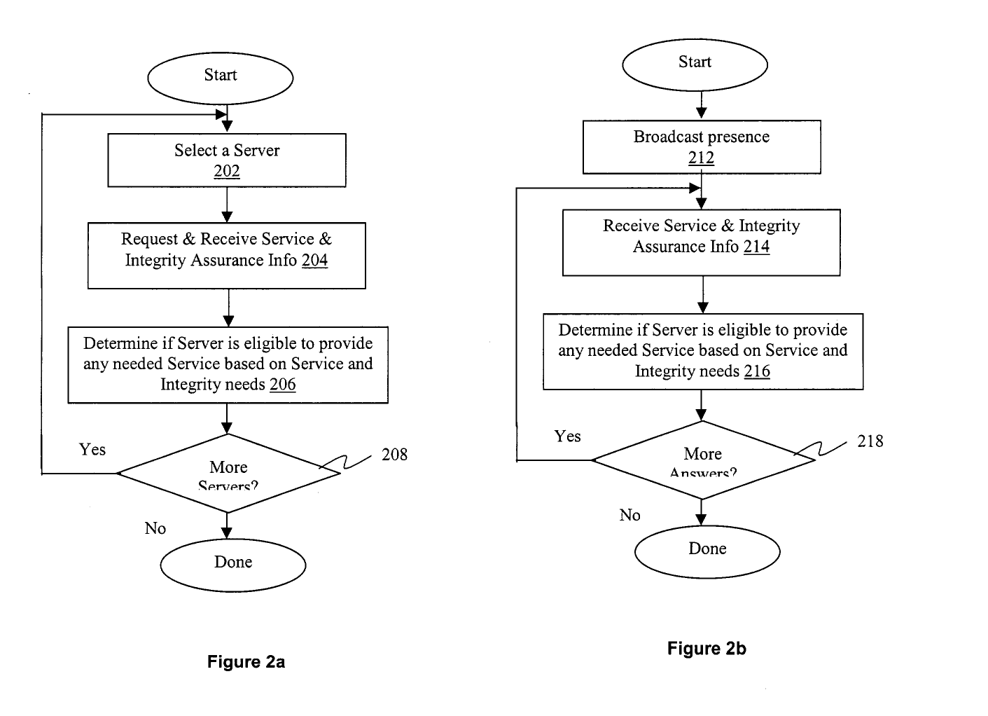

FIGS. 2a-2b illustrate the operational flow of the relevant aspects of the integrity assurance based service selection function 114 of FIG. 1, in accordance with two embodiments. Both of these embodiments assume client 112 is configured with a list of needed services, and periodically determines the servers 122 eligible to provide the needed services, based at least in part on the integrity assurance provided by the service providing servers for the direct service providing components and the supporting components. For the embodiment of FIG. 2a, it is further assumed that client 112 is configured with a list of servers 122 supposedly equipped to provide the needed services.

Accordingly, as illustrated, for the embodiment of FIG. 2a, when it is time to establish or re-establish servers 122 eligibility in providing one or more of the needed services, client 112 selects a server, block 202, and requests the server to provide integrity assurance information for the needed services supposedly may be provided by the server, block 204.

In response, client 112 receives the integrity assurance information, which may be transmitted in any one of a number of message formats, block 204. In alternate embodiment, the information may be provided as a document, e.g. an XML document.

On receipt of the integrity assurance information, client 112 determines whether the server should be identified, or remain identified as being eligible to provide the one or more needed services, block 206. Client 112 may conclude that the server has not been compromised, i.e. the integrity of all direct service providing components as well as supporting components up to n levels removed from the direct service providing components continue to meet the integrity requirements for the one or more needed services. Accordingly, the server is to be considered as eligible to provide each of the one or more needed services.

On the other hand, client 112 may conclude that the server has been partially compromised, i.e. the integrity of the direct service providing components as well as supporting components up to n levels removed from the direct service providing components meet the integrity requirements for some, but not for others of the one or more needed services. Accordingly, the server will be considered eligible to provide the one or more needed services, only for the services where the integrity requirements are being met, or continue being met.

Yet, client 112 may conclude instead that the server has been totally compromised, i.e. the integrity of the direct service providing components as well as supporting components up to n levels removed from the direct service providing components do not meet the integrity requirements for any of the one or more needed services. Accordingly, the server is not to be considered as eligible, or remain eligible to provide any of the one or more needed services.

Upon reaching its conclusions, client 112 determines whether the eligibility of additional servers remains to be established/re-established, block 208. If the eligibility of additional servers is to be established/re-established, client 112 returns to block 202, and continues from there.

If eligibility of all servers has been established/re-established, the process terminates.

FIG. 2b illustrates the process for an alternate embodiment. As described earlier, in this embodiment, client 112 is not configured with a list of servers supposedly eligible to provide the one or more needed services.

Accordingly, as illustrated, for the embodiment of FIG. 2b, when it is time to establish/re-establish the eligibility of one or more servers 122 in providing one or more of the needed services, client 112 broadcasts its presence to the network, block 212, then awaits responses from the listening service providing servers 112.

On reply, client 112 receives the integrity assurance information, which again, as described earlier, may be transmitted in any one of a number of message formats or as documents, block 214.

On receipt of the integrity assurance information, client 112 determines whether the answering server should be identified as being eligible to provide the one or more needed services, block 216. Client 112 may conclude that the answering server to be fully, partially or not eligible to provide the one or more needed services, based at least in part on the assurance information provided, i.e. the integrity of the direct service providing components, and supporting components of one or more levels from the direct service providing components.

Upon reaching its conclusion, client 112 determines if the eligibility of additional answers remains to be processed and analyzed, block 218. If additional answers are to be processed and analyzed, client 112 returns to block 212, and continues from there.

If eligibility of all servers has been established/re-established, the process terminates.

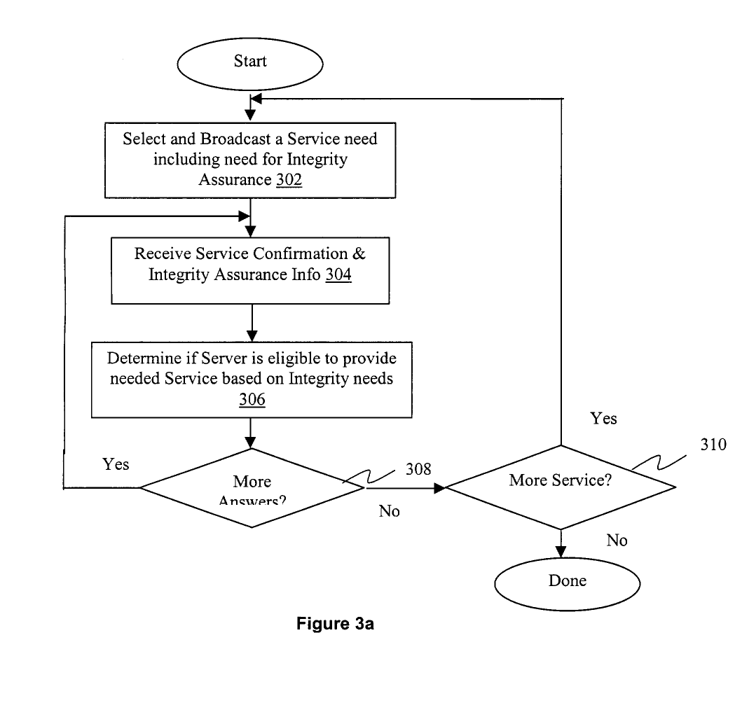

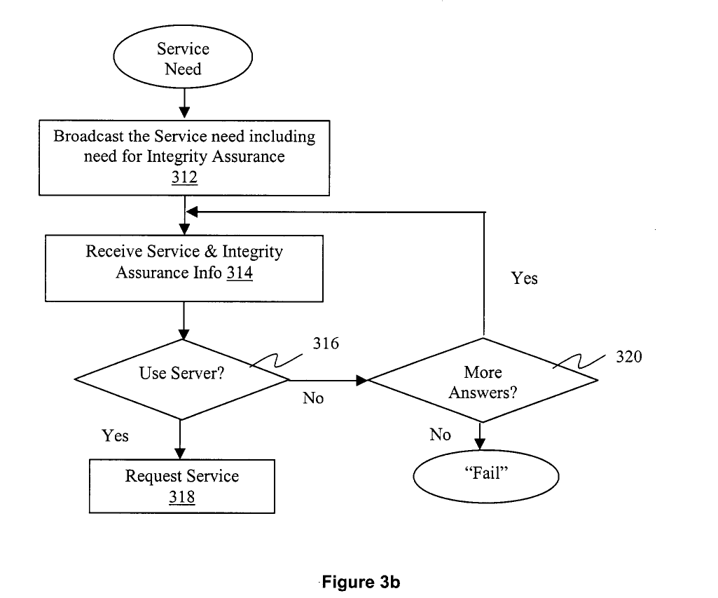

FIGS. 3a-3b illustrate the operational flow of the relevant aspects of the integrity assurance based service selection function 114 of FIG. 1, in accordance with two other embodiments. Similarly, both of these embodiments assume client 112 is configured with a list of needed services, and periodically determines the servers 122 eligible to provide certain needed services based at least in part on the integrity assurance provided by the service providing servers for the direct service providing components and the supporting components.

As illustrated, for the embodiment of FIG. 3a, when it is time to establish/re-establish servers 122 eligibility in providing one or more of the needed services, client 112 selects a service, and broadcasts the need for a service on the network, block 302. In one embodiment, client 112 also broadcasts the integrity requirement for the service, block 302.

On reply of a server, client 112 receives confirmation that the replying server is indeed equipped to provide the service, block 304. Additionally, client 112 receives the integrity assurance information, which may be transmitted in any one of a number of message formats or as documents, block 304.

On receipt of the integrity assurance information, client 112 determines whether the server is to be identified as being eligible to provide the needed services, block 306. Client 112 may conclude that the answering server is eligible or not eligible.

Upon reaching its conclusions, client 112 determines whether eligible servers remain to be established/re-established for one or more other services, block 308. If the eligibility of servers for additional services is to be established/re-established, client 112 returns to block 302, and continues from there.

If eligibility of servers for services has all been established/re-established, the process terminates.

FIG. 3b illustrates the process for an alternate embodiment. In this embodiment, client 112 makes the determination as a service need actually arises, and selects a server to provide the needed service as soon as an eligible server with conforming integrity can be established.

Accordingly, as illustrated, for the embodiment of FIG. 3b, as the service need arises, client 112 broadcasts the need to the network, block 312, then awaits responses from the listening service providing servers 112. In one embodiment, it also broadcasts the integrity assurance requirements.

On reply, client 112 receives the integrity assurance information, which again, as described earlier, may be transmitted in any one of a number of message formats or as documents, block 314.

On receipt of the integrity assurance information, client 112 determines whether the answering server is eligible to provide the one or more needed services, block 316. If the answering server is deemed to be ineligible, client 112 awaits more answers, block 320. If sufficient amount of time has elapsed since the last receipt of an answer, client 112 aborts the service request, as no server with sufficient integrity meeting the requirement has been identified for the needed service.

On the other hand, if client 112 concludes that the answering server is eligible to provide the one or more needed services, based at least in part on the assurance information provided, i.e. the integrity of the direct service providing components, and supporting components of one or more levels from the direct service providing components, client 112 requests the identified server to provide the service immediately, block 318.

In alternate embodiments, in lieu of establishing the eligibility of a server before requesting the server for service, the present invention may be practiced with client 112 requesting the service in parallel, while the integrity of the service providing server is being analyzed. The result of the service is accepted or rejected, based at least in part on whether the service providing server was determined to have the required integrity.

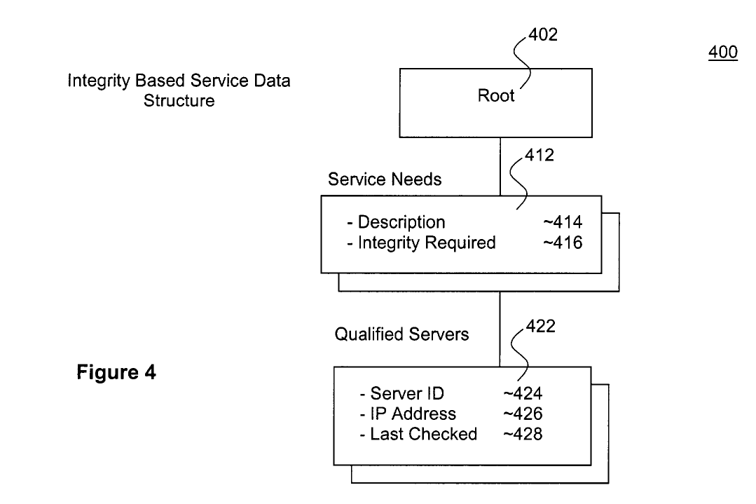

FIG. 4 illustrates a service integrity based service selection data structure suitable for use to practice the present invention, in accordance with one embodiment. As illustrated in FIG. 4, for the embodiment, data structure 400 includes a root object 402 having a number of children Service Need objects 412, which in turn have a number of children Qualified Server objects 422.

Each Service Need object 412 includes in particular Description and Integrity Required attributes 414-416. Description attribute 414 describes the service needed, whereas Integrity Required attribute 416 specifies the “level” of integrity required for the service, e.g. whether no integrity is required, only integrity of the direct service providing components need to be assured, or integrity of support components up to n level(s) removed need to be assured.

Each Qualified Server object 422 includes in particular Server ID, IP Address and Last Checked attributes 424-426. Server ID 414 identifies the qualified server, whereas IP address 416 specifies the network address of the qualified server. Last Checked attribute 426 specifies the last time the integrity of the qualified server was verified as meeting the integrity requirement of the needed service.

### Example Computer System

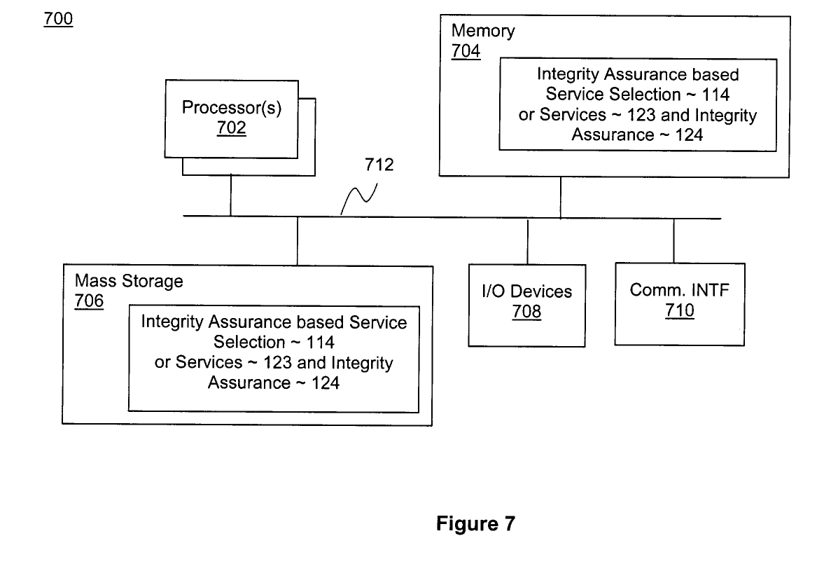

FIG. 7 illustrates an example computer system suitable for use as either a client or a server to practice the present invention, in accordance with one embodiment. Depending on the size, capacity or power of the various elements, example computer system 700 may be used as a server 122 to host the services 123 and the operating system, including integrity assurance manager 124, or as a client 112.

As shown, computer system 700 includes one or more processors 702, and system memory 704. Additionally, computer system 700 includes mass storage devices 706 (such as diskette, hard drive, CDROM and so forth), input/output devices 708 (such as keyboard, cursor control and so forth) and communication interfaces 710 (such as network interface cards, modems and so forth). The elements are coupled to each other via system bus 712, which represents one or more buses. In the case of multiple buses, they are bridged by one or more bus bridges (not shown).

Each of these elements performs its conventional functions known in the art. In particular, when employed as a server 122, system memory 704 and mass storage 706 are employed to store a working copy and a permanent copy of the programming instructions implementing integrity assurance manager 124 and so forth. On the other hand, when employed as a client 112, system memory 704 and mass storage 706 are employed to store a working copy and a permanent copy of the programming instructions implementing integrity assurance based service selection function 114 and so forth. The permanent copy of the programming instructions may be loaded into mass storage 706 in the factory, or in the field, through e.g. a distribution medium (not shown) or through communication interface 710 (from a distribution server (not shown)).

The constitution of these elements 702-712 are known, and accordingly will not be further described.

### Conclusion and Epilogue

Thus, it can be seen from the above descriptions, a novel computing environment with enhanced integrity assurance based service selection, including apparatuses and methods employed or practiced therein has been described.

While the present invention has been described in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. In a networked computing environment, a method of operation comprising:
a client, having a need for one or more services from one or more servers, receiving a transmission from a server indicating integrity assurance for service providing components of one or more services provided by the server, or the absence there of; and
the client determining whether to engage the server to provide one or more of the one or more services needed, based at least in part on said transmission provided by said server.

2. The method of claim 1, wherein said client determining comprises the client determining to engage the server to provide a first of the one or more services needed, based at least in part on the integrity assurance provided for service providing components of the first service meeting integrity requirement of the client for the first needed service.

3. The method of claim 2, wherein said integrity requirement comprises integrity assurance for a direct service providing component of the first service and one or more supporting components up to n level(s) removed from the direct service providing component, where n is an integer, equals to or greater than one.

4. The method of claim 2, wherein said client determining comprises the client determining not to engage the server to provide a second of the one or more services needed, based at least in part on the server failing to provide integrity assurance for service providing component(s) of the second service that meets
integrity requirement of the client for the second needed service, notwithstanding the server is a provider of the second needed service.

5. The method of claim 1, wherein said client determining comprises the client determining not to engage the server to provide a first of the one or more services needed, based at least in part on the server failing to provide integrity assurance for service providing component(s) of the first service that meets integrity requirement of the client for the first needed service, notwithstanding the server is a provider of the first needed service.

6. The method of claim 1, wherein the method further comprises the client requesting the server to provide integrity assurance for service providing components of the service(s) provided, said transmission being provided by the server to the client in response to said request.

7. The method of claim 6, wherein the method further comprises the client repeating said requesting, said receiving and said determining for one or more other servers.

8. The method of claim 6, wherein the method further comprises the client separately or concurrently requesting the server to identify the service(s) provided by the server, and said server identifying the service(s) provided by the server for the client.

9. The method of claim 8, wherein the method further comprises the client repeating said requesting(s), said receiving and said determining for one or more other servers.

10. The method of claim 1, wherein the method further comprises the client broadcasting its presence in the networked computing environment, and said transmission being provided by the server to the client in response to said presence broadcast and comprising service(s) provided by the server.

11. The method of claim 10, wherein the method further comprises the client repeating said receiving and said determining for one or more other servers responding to said presence broadcast of said client.

12. The method of claim 1, wherein the method further comprises the client broadcasting its needs for the one or more services, and said transmission being provided by the server to the client in response to said service needs broadcast.

13. The method of claim 12, wherein the method further comprises the client repeating said receiving and said determining for one or more other servers responding to said service needs broadcast of said client.

14. A networked computing environment comprising:
a first server including first one or more service providing components to provide first one or more services and ability to provide integrity assurance for at least a subset of the first one or more service providing components of the first one or more services; and
a client coupled to the first server and equipped to receive an integrity assurance of one or more of the first one or more service providing components of the first one or more services of the server, and to determine whether to engage the
first server to provide one or more of one or more services needed, based at least in part on the integrity assurance provided by the first server.

15. The networked computing environment of claim 14, wherein said client is equipped to determine to engage the first server to provide a first of the one or more services needed, based at least in part on the integrity assurance provided for service providing components of the first service meeting integrity requirement of the client for the first needed service.

16. The networked computing environment of claim 15, wherein said integrity requirement comprises integrity assurance for a direct service providing component of the first service and one or more supporting components up to n level(s) removed from the direct service providing component, where n is an integer, equals to or greater than one.

17. The networked computing environment of claim 15, wherein said client is equipped to determine not to engage the server to provide a second of the one or more services needed, based at least in part on the first server failing to provide integrity assurance for service providing component(s) of the second service that meets integrity requirement of the client for the second needed service, notwithstanding the server is a provider of the second needed service.

18. The networked computing environment of claim 14, wherein said client is equipped to determine not to engage the first server to provide a first of the one or more services needed, based at least in part on the first server failing to provide integrity assurance for service providing component(s) of the first service that meets integrity requirement of the client for the first needed service, notwithstanding the server is a provider of the first needed service.

19. The networked computing environment of claim 14, wherein the client is further equipped to request the first server to provide integrity assurance for service providing components of the service(s) provided, said transmission being provided by the first server to the client in response to such a request.

20. The networked computing environment of claim 19, wherein
the environment further comprises a second server including second one or more service providing components to provide second one or more services and ability to provide integrity assurance for at least a subset of the second one or more service providing components of the second one or more services; and
the client is further equipped to perform said requesting, said receiving and said determining for the second server.

21. The networked computing environment of claim 19, wherein the client is equipped to separately or concurrently request the first server to identify the service(s) provided by the first server, and said first server identifying the service(s) provided by the first server for the client.

22. The networked computing environment of claim 21, wherein
the environment further comprises a second server including second one or more service providing components to provide second one or more services and ability to provide integrity assurance for at least a subset of the second one or more service providing components of the second one or more services; and
the client is further equipped to perform said requesting, said receiving and said determining for the second server.

23. The networked computing environment of claim 14, wherein the client is equipped to broadcast its presence in the networked computing environment, and the first server is equipped to provide said integrity assurance to the client in response to said presence broadcast and the response including the first one or more services provided by the first server.

24. The networked computing environment of claim 23, wherein
the environment further comprises a second server including second one or more service providing components to provide second one or more services and ability to provide integrity assurance for at least a subset of the second one or more service providing components of the second one or more services in response to said presence broadcast of the client, the response including the second one or more services provided by the second server; and
the client is further equipped to perform said receiving and said determining for the second server.

25. The networked computing environment of claim 14, wherein the method further comprises the client broadcasting its needs for the one or more services, and the first server is equipped to provide the integrity assurance to the client in response to said service needs broadcast.

26. The networked computing environment of claim 25, wherein
the environment further comprises a second server including second one or more service providing components to provide second one or more services and ability to provide integrity assurance for at least a subset of the second one or more service providing components of the second one or more services in response to said service needs broadcast of the client; and
the client is further equipped to perform said receiving and said determining for the second server.

27. In a server, a method of operation comprising:
receiving a selected one of a request and a broadcast of a client coupled to the server; and
in response, providing the client with integrity assurance for service providing components of one or more services provided by the server, or the absence there of, to facilitate the client in determining whether to engage the server in providing one or more of needed services.

28. The method of claim 27, wherein the integrity assurance comprises integrity assurance for direct service providing components of the one or more services and one or more supporting components up to n level(s) removed from the direct service providing components, where n is an integer, equals to or greater than one.

29. The method of claim 27, wherein said receiving comprises receiving a request from the client to provide integrity assurance for service providing components of the one or more services provided by the server.

30. The method of claim 29, wherein
said receiving further comprises receiving separately or concurrently a request from the client to identify the one or more services provided by the server; and
said providing further comprises providing the client with identification of the one or more services provided by the server.

31. The method of claim 27, wherein said receiving comprises receiving a broadcast of the presence of the client in a networked computing environment, and said providing further comprises identification of the one or more services provided by the server.

32. The method of claim 27, wherein said receiving comprises receiving a broadcast of the client of one or more service needs.

33. A server comprising:
storage medium having stored therein a plurality of programming instructions designed to enable the server to
receive a selected one of a request and a broadcast of a client coupled to the server, and
in response, provide the client with integrity assurance for service providing components of one or more services provided by the server, or the absence there of, to facilitate the client in determining whether to engage the server in providing one or more of needed services; and
a processor coupled to the storage medium to execute the programming instructions.

34. The server of claim 33, wherein the integrity assurance comprises integrity assurance for direct service providing components of the one or more services and one or more supporting components up to n level(s) removed from the direct service providing components, where n is an integer, equals to or greater than one.

35. The server of claim 33, wherein the programming instructions are further designed to enable the server to receive separately or concurrently a request from the client to identify the one or more services provided by the server, and to provide the client with identification of the one or more services provided by the server.

36. The method of claim 33, wherein said broadcast is a selected one of a broadcast of the client's presence in a networked computing environment and a broadcast of the client's one or more service needs, and said programming instructions are further designed to enable the server to include with said providing identification of the one or more services provided by the server.

37. In a client, a method of operation comprising
receiving a transmission from a server indicating integrity assurance for service providing components of one or more services provided by the server, or the absence there of; and
determining whether to engage the server to provide one or more of one or more services needed, based at least in part on said transmission provided by said server.

38. The method of claim 37, wherein said determining comprises determining to engage the server to provide a first of the one or more services needed, based at least in part on the integrity assurance provided for service providing components of the first service meeting integrity requirement for the first needed service.

39. The method of claim 38, wherein said integrity requirement comprises integrity assurance for a direct service providing component of the first service and one or more supporting components up to n level(s) removed from the direct service providing component, where n is an integer, equals to or greater than one.

40. The method of claim 38, wherein said determining comprises determining not to engage the server to provide a second of the one or more services needed, based at least in part on the server failing to provide integrity assurance for service providing component(s) of the second service that meets integrity requirement for the second needed service, notwithstanding the server is a provider of the second needed service.

41. The method of claim 37, wherein said determining comprises determining not to engage the server to provide a first of the one or more services needed, based at least in part on the server failing to provide integrity assurance for service providing component(s) of the first service that meets integrity requirement for the first needed service, notwithstanding the server is a provider of the first needed service.

42. The method of claim 37, wherein the method further comprises requesting the server to provide integrity assurance for service providing components of the service(s) provided, said transmission being provided by the server in response to said request.

43. The method of claim 42, wherein the method further comprises repeating said requesting, said receiving and said determining for one or more other servers.

44. The method of claim 42, wherein the method further comprises separately or concurrently requesting the server to identify the service(s) provided by the server, and said server identifying the service(s) provided by the server for the client.

45. The method of claim 44, wherein the method further comprises repeating said requesting(s), said receiving and said determining for one or more other servers.

46. The method of claim 37, wherein the method further comprises broadcasting its presence in the networked computing environment, and said transmission being provided by the server in response to said presence broadcast and comprising service(s) provided by the server.

47. The method of claim 46, wherein the method further comprises repeating said receiving and said determining for one or more other servers responding to said presence broadcast.

48. The method of claim 37, wherein the method further comprises broadcasting needs for the one or more services, and said transmission being provided by the server in response to said service needs broadcast.

49. The method of claim 48, wherein the method further comprises repeating said receiving and said determining for one or more other servers responding to said service needs broadcast of said client.

50. An apparatus comprising:
storage medium having stored therein a plurality of programming instructions designed to enable the apparatus to
receive a transmission from a server indicating integrity assurance for service providing components of one or more services provided by the server, or the absence there of, and
determine whether to engage the server to provide one or more of one or more services needed, based at least in part on said transmission provided by said server; and
a processor coupled to the storage medium to execute the programming instructions.

51. The apparatus of claim 50, wherein said programming instructions are designed to enable the apparatus to determine to engage the server to provide a first of the one or more services needed, based at least in part on the integrity assurance provided for service providing components of the first service meeting integrity requirement for the first needed service.

52. The apparatus of claim 51, wherein said integrity requirement comprises integrity assurance for a direct service providing component of the first service and one or more supporting components up to n level(s) removed from the direct service providing component, where n is an integer, equals to or greater than one.

53. The apparatus of claim 51, wherein said programming instructions are designed to enable the apparatus to determine not to engage the server to provide a second of the one or more services needed, based at least in part on the server failing to provide integrity assurance for service providing component(s) of the second service that meets integrity requirement for the second needed service, notwithstanding the server is a provider of the second needed service.

54. The apparatus of claim 50, wherein said programming instructions are designed to enable the apparatus to determine not to engage the server to provide a first of the one or more services needed, based at least in part on the server failing to provide integrity assurance for service providing component(s) of the first service that meets integrity requirement for the first needed service, notwithstanding the server is a provider of the first needed service.

55. The apparatus of claim 50, wherein said programming instructions are further designed to enable the apparatus to request the server to provide integrity assurance for service providing components of the service(s) provided, said transmission being provided by the server in response to such a request.

56. The apparatus of claim 55, wherein said programming instructions are further designed to enable the apparatus to repeat said requesting, said receiving and said determining for one or more other servers.

57. The apparatus of claim 55, wherein said programming instructions are further designed to enable the apparatus to separately or concurrently request the server to identify the service(s) provided by the server, and to receive from said server identification of the service(s) provided by the server.

58. The apparatus of claim 57, wherein said programming instructions are further designed to enable the apparatus to repeat said requesting, said receiving and said determining for one or more other servers.

59. The apparatus of claim 50, wherein said programming instructions are further designed to enable the apparatus to broadcast presence of the apparatus in a networked computing environment, and said transmission is provided in response to said presence broadcast, the response including the first one or more services provided by the server.

60. The apparatus of claim 59, wherein said programming instructions are further designed to enable the apparatus to repeat said receiving and said determining for one or more other servers.

61. The apparatus of claim 50, wherein said programming instructions are further designed to enable the apparatus to broadcast needs for the one or more services, and said transmission is provided in response to said service needs broadcast.

62. The apparatus of claim 61, wherein said programming instructions are further designed to enable the apparatus to repeat said receiving and said determining for one or more other servers.

63. The apparatus of claim 50, wherein the apparatus is a selected one of a wireless mobile phone, a personal digital assistant, a palm-sized computing device, a laptop computer, a desktop computer and a set-top box.
